(19) United States
(12) Patent Application Publication
(10) Pub. No.: US 2012/0273661 A1
(43) Pub. Date: Nov. 1, 2012

(54) APPARATUS AND METHOD FOR DECIDING ENTRANCE AND EXIT OF MOVING OBJECTS

(76) Inventor: IN CHUN LEE, Los Angeles, CA (US)

(21) Appl. No.: 13/407,869

(22) Filed: Feb. 29, 2012

(30) Foreign Application Priority Data
Apr. 26, 2011 (KR) 10-2011-0039214

(51) Int. Cl. G01J 1/44

(52) U.S. Cl. 250/214.1

(57) ABSTRACT

Present invention proposes an apparatus and method for deciding entrance and exit of moving objects using two or more transmission units and only one reception unit which are installed on a gateway of a space to be measured. The two or more transmission units comprises a first transmission unit installed on one side surface of a gateway of a space to be measured to emit a first pulse in a first period; a second transmission unit installed in an inside direction of the space on the installation surface of the first transmission unit to emit a second pulse which has the first period and a phase that is different from a phase of the first pulse.

### CROSS-REFERENCE TO RELATED APPLICATION

This application is based on and claims priority from Korean Patent Application No. 10-2011-0039214, filed on Apr. 26, 2011, in the Korean Intellectual Property Office, the disclosure of which is incorporated herein in its entirety by reference.

### BACKGROUND OF THE INVENTION

1. Field of the Invention

The present invention relates to an apparatus and method for deciding entrance and exit of moving objects, which is provided on a gateway of a space to be measured.

2. Description of the Prior Art

As energy saving has become more important, there has been a demand for a technique of deciding whether persons are present in a specified space in order to minimize energy consumption in the corresponding space in the case where no person is present in the space. According to a corresponding system in the related art, sensors for sensing movement of moving objects are installed in a space to be measured, and if no movement of the moving objects is sensed, it is decided that no person is present in the space. However, the system in the related art has the problem in that it decides that no person is present in the corresponding space even in the case where persons with no movement are actually present in the space.

### SUMMARY OF THE INVENTION

Accordingly, the present invention has been made to solve the above-mentioned problems occurring in the prior art, and proposes an apparatus and method for deciding entrance and exit of moving objects using two or more transmission units and one reception unit which are installed on a gateway of a space to be measured.

The present invention also proposes an apparatus and method for deciding entrance and exit of moving objects which can detect the number of moving objects that are present in a space to be measured based on the entrance and exit of the moving objects through a gateway of the space.

The present invention also proposes an apparatus and method for deciding entrance and exit of moving objects which can transmit control signals for controlling devices positioned in a space to be measured in accordance with the number of moving objects that are present in the space.

Additional advantages, objects, and features of the invention will be set forth in part in the description which follows and in part will become apparent to those having ordinary skill in the art upon examination of the following or may be learned from practice of the invention.

According to an aspect of the present invention, there is provided an apparatus for deciding entrance and exit of moving objects comprising: a first transmission unit installed on one side surface of a gateway of a space to be measured to emit a first pulse in a first period; a second transmission unit installed in an inside direction of the space on the installation surface of the first transmission unit to emit a second pulse which has the first period and a phase that is different from a phase of the first pulse; a reception unit installed on an opposite side to the installation surface of the first transmission unit to receive a synthetic pulse in which the first pulse and the second pulse are selectively synthesized according to the entrance/exit of the moving objects; and an entrance/exit decision unit determining whether a moving object has entered or left the space according to a change of a waveform of the synthetic pulse.

According to another aspect of the present invention, there is provided an apparatus for deciding entrance and exit of moving objects, comprising: a first transmission unit installed on one side surface of a gateway of a space to be measured to emit a first pulse in a first period; a second transmission unit installed in an inside direction of the space on the installation surface of the first transmission unit to emit a second pulse which has the first period and a phase that is different from a phase of the first pulse; a reflection means installed on an opposite side to the installation surface of the first transmission unit to reflect the first pulse and the second pulse; a reception unit installed between the first transmission unit and the second transmission unit on the installation surface of the first transmission unit to receive a synthetic pulse in which the first pulse and the second pulse are selectively synthesized according to the entrance/exit of the moving objects; and an entrance/exit decision unit determining whether a moving object has entered or left the space according to a change of a waveform of the synthetic pulse.

According to another aspect of the present invention, there is provided a method of deciding entrance and exit of moving objects, comprising: emitting a first pulse in a first period through a first transmission unit installed on one side surface of a gateway of a space to be measured; emitting a second pulse which has the first period and a phase that is different from a phase of the first pulse through a second transmission unit installed in an inside direction of the space on the installation surface of the first transmission unit to emit; receiving a synthetic pulse in which the first pulse and the second pulse are selectively synthesized according to the entrance/exit of the moving objects through a reception unit installed on an opposite side to the installation surface of the first transmission unit; and determining whether a moving object has entered or left the space according to a change of a waveform of the received synthetic pulse.

According to the present invention as described above, the entrance and exit of moving objects can be decided using two or more transmission units and one reception unit which are installed on the gateway of the space. That is, since the entrance and exit of the moving objects can be decided using only one reception unit, the cost for installing the apparatus for deciding the entrance and exit of the moving objects.

Further, the number of moving objects that are present in the space can be grasped based on the entrance and exit of the moving objects through the gateway of the space, and thus electrical devices installed in the space can be controlled accordingly.

### BRIEF DESCRIPTION OF THE DRAWINGS

The above and other objects, features and advantages of the present invention will be more apparent from the following detailed description taken in conjunction with the accompanying drawings, in which:

FIG. 1 is a conceptual diagram of an arrangement of an apparatus for deciding the entrance and exit of moving objects according to an embodiment of the present invention;

FIG. 2 is a diagram illustrating the configuration of an apparatus for deciding the entrance and exit of moving objects according to an embodiment of the present invention;

FIG. 3A is a diagram illustrating the reception state of a signal that indicates the state where a moving object is not sensed in an apparatus for deciding the entrance and exist of moving objects according to an embodiment of the present invention;

FIG. 3B is a diagram illustrating the reception state of a signal that indicates the state where a moving object is sensed in an apparatus for deciding the entrance and exist of moving objects according to an embodiment of the present invention is received;

FIG. 4A is a diagram illustrating the reception state of a signal that indicates the state where a moving object is not sensed in an apparatus for deciding the entrance and exist of moving objects according to an embodiment of the present invention is received; and

FIG. 4B is a diagram illustrating the reception state of a signal that indicates the state where a moving object is sensed in an apparatus for deciding the entrance and exist of moving objects according to an embodiment of the present invention is received;

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present. Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

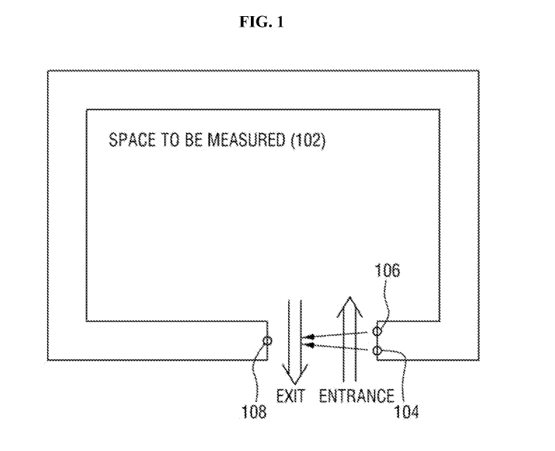

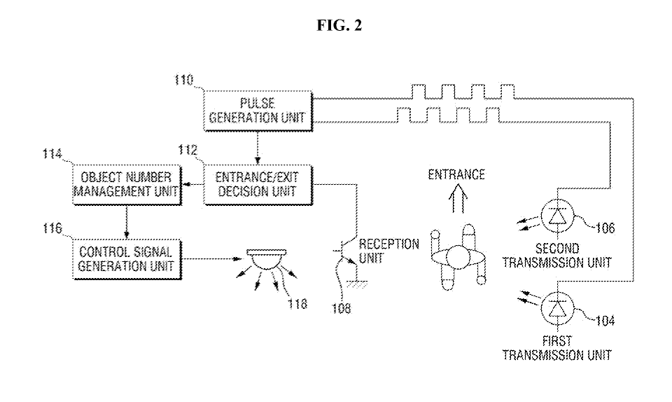

Hereinafter, the configuration and operation of an apparatus for deciding the entrance and exit of moving objects according preferred embodiments of the present invention will be described with reference to FIGS. 1 and 2. FIG. 1 is a conceptual diagram of an arrangement of an apparatus for deciding the entrance and exit of moving objects according to an embodiment of the present invention, and FIG. 2 is a diagram illustrating the configuration of an apparatus for deciding the entrance and exit of moving objects according to an embodiment of the present invention.

As illustrated in FIG. 1, a first transmission unit 104, a second transmission unit 106, and a reception unit 108 are installed on both sides of a gateway of a space 102 to be measured. In this case, it is required that the reception unit 108 is installed in a position that is opposite to the first transmission unit 104 and the second transmission unit 106. The first transmission unit 104 and the second transmission unit 106 are not installed in parallel to each other in a direction that is vertical to ground, but are installed to be apart for a predetermined width from each other in a direction that is horizontal to the ground. Hereinafter, the transmission unit that is installed to be relatively close to the space 102 on the installation surface of the first transmission unit 104 is called the second transmission unit 106.

The reception unit 108 is a device capable of receiving an electromagnetic wave signal and detecting the wavelength thereof. It is required that this electromagnetic wave signal cannot pass through a moving object that blocks off the electromagnetic wave signal, and has straightness so much that it does not reach the reception unit 108 round the moving object that blocks off the electromagnetic wave signal.

The reception unit 108 may be, for example, a manual infrared sensor or a laser sensor. In this case, it is required that the first transmission unit 104 and the second transmission unit 106 emit infrared rays or laser beams toward the reception unit 108.

According to an embodiment of the present invention, the reception unit 108 may include an RF (Radio Frequency) signal receiver. In this case, it is required that the first transmission unit 104 and the second transmission unit 106 generate an RF signal which has the signal strength so much that it cannot pass through the moving object and the straightness so much that it cannot reach the reception unit 108 round the moving object that blocks off the RF signal.

The first transmission unit 104 emits a first pulse in a first period, and the second transmission unit 104 emits a second pulse in the first period. The electromagnetic wave signals having the same period means the electromagnetic wave signals having the same frequency, and unless an obstacle is present between the reception unit 108 and the first transmission unit 104 and the second transmission unit 106, the reception unit 108 will receive a synthetic pulse of the first pulse and the second pulse.

However, the first pulse and the second pulse have a phase difference from each other. Since the first pulse and the second pulse have the same period, but have the phase difference, the synthetic pulse of the first pulse and the second pulse has different waveforms in the case where the first pulse is blocked off and is not received in the reception unit 108, in the case where the second pulse is blocked off and is not received in the reception unit 108, and in the case where both the first pulse and the second pulse are blocked off and are not received in the reception unit 108, respectively.

The phase difference may be, for example, a half of the first period. That is, if the first pulse has an amplitude that corresponds to “1” in the first half period and has an amplitude that corresponds to “0” in the latter half period, the second pulse may repeat “1” and “0” in an alternate manner together with the first pulse. In the case where the first pulse and the second pulse are infrared signals or laser signals, they may be signals that alternately go on and off.

The apparatus for deciding the entrance and exit of moving objects according to the embodiment of the present invention may decide whether a moving object has entered or left the space 102 according to the change of the waveforms that are received by the reception unit 108. The details of the decision of whether the moving object has entered or left the space 102 according to the change of the waveforms received by the reception unit 108 will be described with reference to FIG. 2.

FIG. 2 illustrates constituent elements that are included in the apparatus for deciding the entrance and exit of moving objects according to an embodiment of the present invention in the form of blocks. In this case, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As illustrated in FIG. 2, the apparatus for deciding the entrance and exit of moving objects according to an embodiment of the present invention may include the first transmission unit 104, the second transmission unit 106, the reception unit 108, and an entrance/exit decision unit 112. As described above, the first transmission unit 104 is installed on one side surface of a gateway of a space 102 to be measured to emit the first pulse in the first period, and the second transmission unit 106 is installed to be relatively close to the space 102 on the installation surface of the first transmission unit 104 to emit the second pulse which has the first period and the phase that is different from the phase of the first pulse. Further, the reception unit 108 is installed on the opposite side to the installation surface of the first transmission unit 104, and receives a synthetic pulse in which the first pulse and the second pulse are selectively synthesized according to the entrance/exit of the moving objects. The term “selectively synthesized” means that at least one of the first pulse and the second pulse may not be included in the synthetic pulse.

The pulse generation unit 110 generates and provides the first pulse and the second pulse to the first transmission unit 104 and the second transmission unit 106, respectively. As described above, the first pulse and the second pulse are limited to have the same period and the phase difference from each other. Although it is preferable that the waveforms of the first pulse and the second pulse are the same, it is to be noted that they may be different from each other.

The entrance/exit decision unit 112 receives the synthetic pulse from the reception unit 108. Further, the entrance/exit decision unit 112 may receive information on the synthetic pulse that is digitally converted through an ADC (Analog-Digital Converter, not illustrated) connected between the reception unit 108 and the entrance/exist decision unit 112.

The entrance/exit decision unit 112 decides whether a moving object has entered or left the space 102 according to the change of the synthetic pulse waveform. More specifically, the entrance/exit decision unit 112 decides whether at least one of the first pulse and the second pulse is not received using the phase difference between the first pulse and the second pulse, and decides whether a moving object has entered or left the space according to the result of decision.

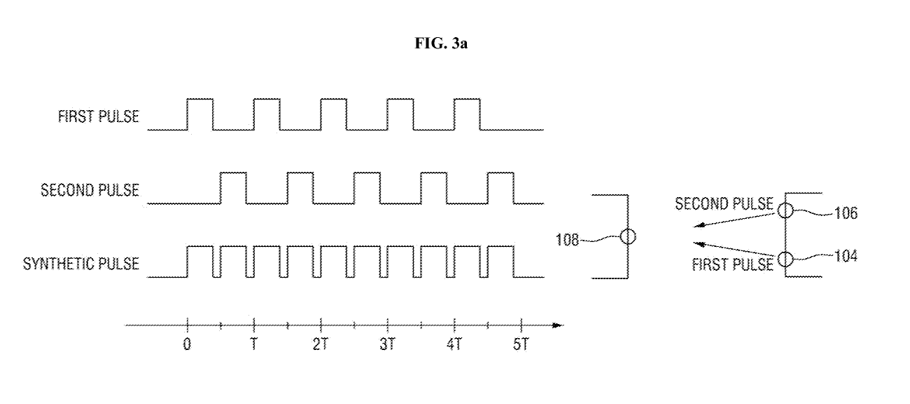

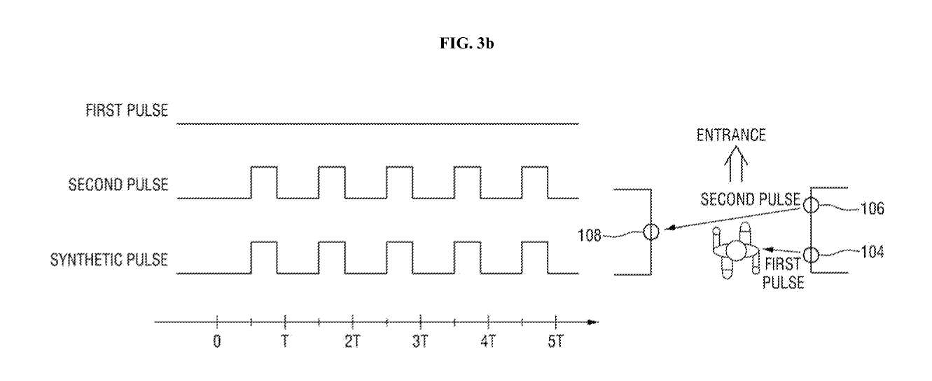

The operation of the entrance/exit decision unit 112 will be described in more detail with reference to FIGS. 3A and 3B.

FIG. 3A illustrates the reception state of a signal that indicates the state where a moving object is not sensed. As illustrated in FIG. 3A, since there is no obstacle, the first pulse that is emitted by the first transmission unit 104 and the second pulse that is emitted by the second transmission unit 106 are received in the reception unit 108 in the form of a synthetic pulse as illustrated in FIG. 3A. The first pulse as illustrate in FIG. 3A is in an on state for a predetermined time in the first half of one period T and is in an off state for the predetermined time in the latter half of the period T. The second pulse is in an off state for a predetermined time in the first half of one period T and is in an on state for the predetermined time in the latter half of the period T. In this case, the phase difference between the first pulse and the second pulse may be a half period (T/2). Further, the synthetic pulse is in an on state for a predetermined time in the first half period and in the latter half period, respectively. The entrance/exist decision unit 112 decides that all the first pulse and the second pulse are received in the case where the synthetic pulse as illustrated in FIG. 3A is received.

FIG. 3B illustrates the reception state of a signal in the case where a moving object is sensed, and more particularly, in a state where the first pulse is not received. The first pulse and the second pulse in FIG. 3B are equal to the first pulse and the second pulse in FIG. 3A. As illustrated in FIG. 3B, in the case where the moving object enters the space 102, the first pulse is not received first prior to the second pulse. In this case, the synthetic pulse does not include the first pulse, but includes the second pulse only. If the synthetic pulse as illustrated in FIG. 3B is received, the entrance/exit decision unit 112 decides that only the second pulse is received. On the contrary to that illustrated in FIG. 3B, in the case where the moving object leaves the space 102, the second pulse is not received first. In this case, the synthetic pulse includes only the first pulse.

As illustrated in FIGS. 3A and 3B, the first pulse and the second pulse have the same period and different phases, and in the case where both the first pulse and the second pulse are synthesized, in the case where only the first pulse is received, and in the case where only the second pulse is received, the synthetic pulse has different shapes of waveforms, respectively. Accordingly, the entrance/exit decision unit 112 can decide whether at least one of the first pulse and the second pulse is not received based on the waveform of the synthetic pulse.

On the other hand, as the moving object enters or leaves the space 102, the waveform of the synthetic pulse is changed. For example, in the case where the moving object enters the space 102, the synthetic pulse that includes both the first pulse and the second pulse is received first, the synthetic pulse that includes only the second pulse is received, and the synthetic pulse that includes only the first pulse is received. Finally, if the moving object completely passes through the space 102, the synthetic pulse that includes both the first pulse and the second pulse is finally received. Using this point, the entrance/exist decision unit 112 can decide whether the moving object has entered or left the space according to the change of the synthetic pulse waveform.

The entrance/exit decision unit 112 may decide the entrance or exit of the moving object based on the pulse that is not received first. That is, if the first pulse is not received in a state where both the first pulse and the second pulse are received, the entrance/exit decision unit 112 may decide that the moving object is entering the space, while if the second pulse is not received in a state where both the first pulse and the second pulse are received, the entrance/exit decision unit 112 may decide that the moving object is leaving the space.

Further, the entrance/exit decision unit 112 may decide the entrance or exit of the moving object based on the pulse that is not received later. That is, if the second pulse is not received in a predetermined time after the occurrence of non-reception of the first pulse, the entrance/exit decision unit 112 may decide that the moving object has entered the space, while if the first pulse is not received in a predetermined time after the occurrence of non-reception of the second pulse, the entrance/exit decision unit 112 may decide that the moving object has left the space. In this case, noise can be filtered, which occurs when the first pulse or the second pulse is not received due to the fact that a moving object's arm or collar goes through the gateway of the space rather than due to the moving object's entrance or exit

Further, the entrance/exit decision unit 112 may decide the entrance or exit in consideration of both the non-reception order and the reception order of the pulse. That is, the entrance/exit decision unit 112 may decide that the moving object has entered the space to be measured in the case where the second pulse is not received after the occurrence of non-reception of the first pulse, and then the second pulse is received again after the reception of the first pulse, while the entrance/exit decision unit 112 may decide that the moving object has left the space in the case where the first pulse is not received after the occurrence of non-reception of the second pulse, and then the first pulse is received again after the reception of the second pulse. In this case, the entrance or exit of the moving object is decided only in the case where the moving object passes through the gateway of the space, and thus the above-described noise can be filtered.

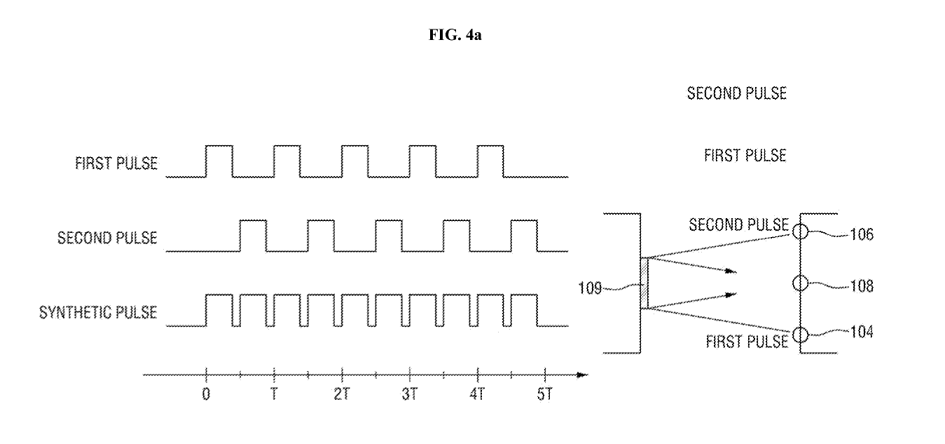

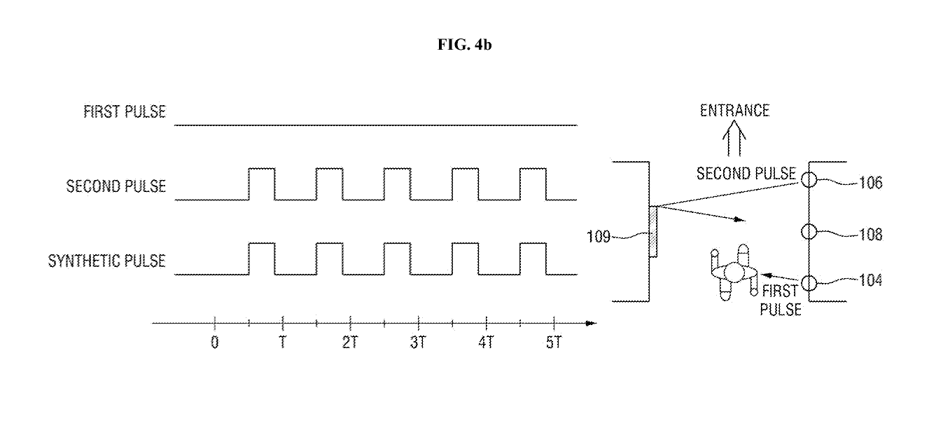

On the other hand, as illustrated in FIGS. 4A and 4B, the first transmission unit 104, the second transmission unit 106, and the reception unit 108 may be installed on the same side surface of the gateway of the space. More specifically, the reception unit 108 and the second transmission unit 106 may be installed in order in the inside direction of the space of the first transmission unit 106. In this case, on the opposite side surface to the installation surface of the first transmission unit 104, the second transmission unit 106, and the reception unit 108, a pulse reflection means 109 may be installed. It is preferable that the pulse reflection means 109 is installed in a position where the first pulse and the second pulse are reflected to be projected to the reception unit 108. On the other hand, unlike that as illustrated in FIG. 4A, the pulse reflection means 109 may be physically separated into a first reflection means for reflecting the first pulse and a second reflection means for reflecting the second pulse.

As illustrated in FIGS. 4A and 4B, in the case where the first transmission unit 104, the second transmission unit 106, and the reception unit 108 are installed on the same side surface of the gateway, they may be configured as one installation module in which they are physically connected, and thus the installation becomes simplified. Further, in the case where the first transmission unit 104, the second transmission unit 106, and the reception unit 108 are installed on opposite side surfaces of the gateway, the opposite side surfaces require wiring, whereas in the case where the first transmission unit 104, the second transmission unit 106, and the reception unit 108 are installed on the same side surface, wiring is required only on one side surface, and thus the installation cost can be minimized. Even in the case where the first transmission unit 104, the second transmission unit 106, and the reception unit 108 are installed as illustrated in FIGS. 4A and 4B, the operation of the entrance/exit decision unit 112 is the same as that illustrated in FIGS. 3A and 3B, and thus the description of the operation thereof will be omitted.

Referring again to FIG. 2, the configuration and the operation of the apparatus for deciding the entrance and exit of the moving object according to an embodiment of the present invention will be described. The apparatus for deciding the entrance and exit of the moving object according to an embodiment of the present invention may further include an object number management unit 114 that manages the number of moving objects in the space by reflecting whether the moving objects have entered or left the space 102 through the entrance/exit decision unit 112. The object number management unit 114 may manages the number of moving objects in a manner that the object number management unit 114 sets the number of objects in an initial state to “0”, and if it is decided that the moving object has entered the space 102, it sets the number of objects by “+1”, while if it is decided that the moving object has left the space 102, it sets the number of objects by “−1”.

Data of the number of moving objects in the space may be stored in a storage means (not illustrated). The storage means may be, but is not limited to, one of a nonvolatile memory device, such as a cache, a ROM (Read Only Memory), a PROM (Programmable ROM), an EPROM (Erasable Programmable ROM), an EEPROM (Electrically Erasable Programmable ROM), and a flash memory, a volatile memory device such as a RAM (Random Access Memory), and a storage medium such as a hark disk drive.

Further, the data of the number of moving objects stored in the storage means may be transmitted to a central management server through a network interface (not illustrated), or may be accessed by the central management server.

The apparatus for deciding the entrance and exit of the moving objects according to an embodiment of the present invention may further include a control signal generation unit 116 which generates a control signal for controlling a device 118 that operates in the space 102 based on the number of moving objects managed by the object number management unit 114. For example, if the number of moving objects becomes “0”, the control signal generation unit 116 may generate a control signal for making electric lamps turned off and provide the control signal to the electric lamps.

Although the entrance/exit decision unit 112, the object number management unit 114, and the control signal generation unit 116 are illustrated as separate blocks in FIG. 2, it is to be noted that they may be mounted on one processor according to the embodiments of the present invention.

Although preferred embodiments of the present invention have been described for illustrative purposes, those skilled in the art will appreciate that various modifications, additions and substitutions are possible, without departing from the scope and spirit of the invention as disclosed in the accompanying claims.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. An apparatus for deciding entrance and exit of moving objects, comprising:
a first transmission unit installed on one side surface of a gateway of a space to be measured to emit a first pulse in a first period;
a second transmission unit installed in an inside direction of the space on the installation surface of the first transmission unit to emit a second pulse which has the first period and a phase that is different from a phase of the first pulse;
a reception unit installed on an opposite side to the installation surface of the first transmission unit to receive a synthetic pulse in which the first pulse and the second pulse are selectively synthesized according to the entrance/exit of the moving objects; and
an entrance/exit decision unit determining whether a moving object has entered or left the space according to a change of a waveform of the synthetic pulse.

2. The apparatus for deciding entrance and exit of moving objects of claim 1, wherein the first pulse and the second pulse are signals having straightness.

3. The apparatus for deciding entrance and exit of moving objects of claim 2, wherein the first pulse and the second pulse are one of infrared rays and laser beams, the first pulse is a blinking signal, and the second pulse is a signal that blinks alternately with the first pulse.

4. The apparatus for deciding entrance and exit of moving objects of claim 1, wherein the entrance/exit decision unit decides whether at least one of the first pulse and the second pulse is not received using the phase difference between the first pulse and the second pulse, and decides whether a moving object has entered or left the space according to the result of decision.

5. The apparatus for deciding entrance and exit of moving objects of claim 4, wherein if the first pulse is not received in a state where both the first pulse and the second pulse are received, the entrance/exit decision unit decides that the moving object is entering the space, while if the second pulse is not received in a state where both the first pulse and the second pulse are received, the entrance/exit decision unit decides that the moving object is leaving the space.

6. The apparatus for deciding entrance and exit of moving objects of claim 4, wherein if the second pulse is not received in a predetermined time after the occurrence of non-reception of the first pulse, the entrance/exit decision unit decides that the moving object has entered the space, while if the first pulse is not received in a predetermined time after the occurrence of non-reception of the second pulse, the entrance/exit decision unit decides that the moving object has left the space.

7. The apparatus for deciding entrance and exit of moving objects of claim 4, wherein the entrance/exit decision unit decides that the moving object has entered the space in the case where the second pulse is not received after the occurrence of non-reception of the first pulse, and then the second pulse is received again after the reception of the first pulse, while the entrance/exit decision unit decides that the moving object has left the space in the case where the first pulse is not received after the occurrence of non-reception of the second pulse, and then the first pulse is received again after the reception of the second pulse.

8. The apparatus for deciding entrance and exit of moving objects of claim 1, further comprising an object number management unit that manages the number of moving objects in the space by reflecting whether the moving objects have entered or left the space.

9. The apparatus for deciding entrance and exit of moving objects of claim 8, further comprising a control signal generation unit which generates a control signal for controlling a device that operates in the space based on the number of moving objects managed by the object number management unit.

10. An apparatus for deciding entrance and exit of moving objects, comprising:
a first transmission unit installed on one side surface of a gateway of a space to be measured to emit a first pulse in a first period;
a second transmission unit installed in an inside direction of the space on the installation surface of the first transmission unit to emit a second pulse which has the first period and a phase that is different from a phase of the first pulse;
a reflection means installed on an opposite side to the installation surface of the first transmission unit to reflect the first pulse and the second pulse;
a reception unit installed between the first transmission unit and the second transmission unit on the installation surface of the first transmission unit to receive a synthetic pulse in which the first pulse and the second pulse are selectively synthesized according to the entrance/exit of the moving objects; and
an entrance/exit decision unit determining whether a moving object has entered or left the space according to a change of a waveform of the synthetic pulse.

11. A method of deciding entrance and exit of moving objects, comprising:
emitting a first pulse in a first period through a first transmission unit installed on one side surface of a gateway of a space to be measured;
emitting a second pulse which has the first period and a phase that is different from a phase of the first pulse through a second transmission unit installed in an inside direction of the space on the installation surface of the first transmission unit to emit;
receiving a synthetic pulse in which the first pulse and the second pulse are selectively synthesized according to the entrance/exit of the moving objects through a reception unit installed on an opposite side to the installation surface of the first transmission unit; and
determining whether a moving object has entered or left the space according to a change of a waveform of the received synthetic pulse.

12. The method of deciding entrance and exit of moving objects of claim 11, further comprising managing the number of moving objects in the space by reflecting whether the moving objects have entered or left the space.

13. The method of deciding entrance and exit of moving objects of claim 12, further comprising generating a control signal for controlling a device that operates in the space based on the number of moving objects.
